(19) United States
(12) Patent Application Publication
(10) Pub. No.: US 2023/0138244 A1
(43) Pub. Date: May 4, 2023

(54) SENSOR INPUT DETECTION

(71) Applicant: Hewlett-Packard Development Company, L.P., Spring, TX (US)

(72) Inventors: Wei Hung Lin, Taipei City (TW); Hung Sung Pan, Taipei City (TW); Simon Wong, Spring, TX (US)

(73) Assignee: Hewlett-Packard Development Company, L.P., Spring, TX (US)

(21) Appl. No.: 17/911,542

(22) PCT Filed: Apr. 7, 2020
(86) PCT No.: PCT/US2020/027018

§ 371 Date: Sep. 14, 2022

(51) Int. Cl. G06F 3/03; G06F 1/16; G06F 3/01; G06F 3/0354

(52) U.S. Cl. CPC G06F 3/0304; G06F 1/169; G06F 3/017; G06F 3/03545

(57) ABSTRACT

An example approach to detect inputs using a sensor is disclosed. In an example, an electronic device may include a housing, an optical sensor to detect an input from a detection zone, and a rotatable housing mounted to a side of the housing. The optical sensor is disposed in the rotatable housing. The electronic device may also include a direction sensor to detect an orientation of the rotatable housing relative to the housing.

### BACKGROUND

Electronic devices, such as laptop computers, tablet computers, and smartphones, may include touchpads, displays, and keyboards. Touchpads, touchscreens, and keyboards may receive user input, such as clicks, scrolls, and/or taps. The touchpads and keyboards may be located on electronic device itself or be located on an electronic device external to the electronic device.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIG. 1A illustrates an electronic device having a sensor to detect an input, according to an example;

FIG. 1B illustrates a laptop computer housing a sensor to detect an input, according to an example;

FIG. 2A illustrates an electronic device having a first sensor and a second sensor to detect an input, according to an example;

FIG. 2B illustrates a laptop computer housing a first sensor and a second sensor to detect an input, according to an example;

FIG. 3A illustrates an orientation for a sensor of zero degrees, according to an example;

FIG. 3B illustrates an orientation for a sensor of ninety degrees, according to an example;

FIGS. 4A-D illustrate operation modes for an electronic device with a sensor orientation of zero degrees, according to another example;

FIGS. 5A-D illustrate operation modes for an electronic device with a sensor orientation of zero degrees, according to another example;

FIGS. 6A-C is a illustrates a sensor rotation mechanism, according to another example;

FIG. 7A illustrates is a system of an electronic device and a stylus having a sensor to detect an input, according to another example;

FIG. 7B illustrates is a block diagram of a stylus having a sensor to detect an input, according to another example; and

FIG. 8 illustrates a method for operating an optical sensor, according to another example.

### DETAILED DESCRIPTION

An electronic device, such as a laptop computer, tablet computer, smartphone, etc., may include input devices to receive user inputs, such as a touchpad, a touchscreen, and/or a keyboard. However, implementing touchpads, touchscreens, and/or keyboards into electronic devices requires additional space in the electronic device. Furthermore, interacting with the input devices generally involves the user touching the electronic device with their fingers. This can cause the electronic device to collect additional composites on its surface where the input device is located. In some instances, the electronic device may even be damaged by composite buildup and/or external substances working their way to internal components of the electronic device.

Examples described herein provide an approach to detect inputs using a sensor. In an example, an electronic device may include a housing, an optical sensor to detect an input from a detection zone, and a rotatable housing mounted to a side of the housing, where the optical sensor is disposed in the rotatable housing. The electronic device may also include a direction sensor to detect an orientation of the rotatable housing relative to the housing.

In another example, an electronic device may include a housing and a first optical sensor to detect a first input from a first virtual touchpad. The first rotatable housing may be mounted to a first side of the housing, where the first sensor is disposed in the first rotatable housing. The electronic device may also include a second sensor to detect a second input from a second virtual touchpad and a second rotatable housing mounted to a second side of the housing, where the second sensor is disposed in the second rotatable housing.

In another example, a system may include an electronic device and an optical sensor to detect an input for the electronic device. The system may also include a stylus having a body and a tip, where the optical sensor is disposed in the body. In this example, the optical sensor may be oriented perpendicular to the tip, where the stylus is to transmit the input to the electronic device.

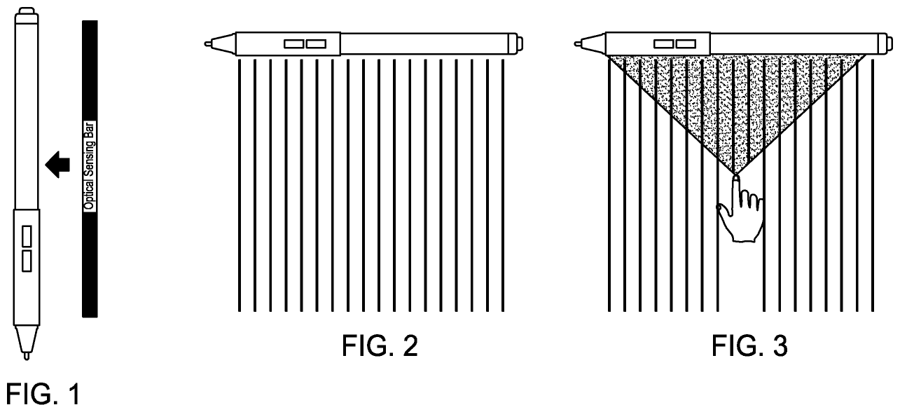

FIGS. 1A-1B illustrate an electronic device 100 having a sensor to detect an input, according to an example. Electronic device 100 may be, for example, a notebook computer, a tablet computer, etc. Electronic device 100 may include a housing 102 and a rotatable housing 104. Electronic device 100 may also include an optical sensor 106 disposed in the rotatable housing 104. Furthermore, electronic device 100 may include a direction sensor 108, a controller 110, and an orientation sensor 112.

Housing 102 may be attached to rotatable housing 104 by a biasing member, such as a bi-stable spring, an example of which is shown in FIG. 6. Rotatable housing 104 may include an opening extending along the edge of rotatable housing 104. The opening may allow optical sensor 106 to detect a user input by detecting a change in light and converting the change in light into an electrical signal. The electrical signal may then be processed by a processor to determine the user input. While this example includes an optical sensor, it should be noted that other sensors may be used to detect a user input, such as laser, soundwave, a magnetometer sensor, or some other sensor which may detect a gesture indicating a user input.

Electronic device 100 may further include direction sensor 108. Direction sensor 108 may be located in rotatable housing 104 to determine a degree to which the front of optical sensor 106 is directed relative to the surface of the base of electronic device 100. Orientation sensor 112 may also be used in electronic device 100 to determine a mode in which electronic device 100. Orientation sensor 112 may be implemented using an accelerometer. Electronic device 100 may further include controller 110 to determine an operation mode of the optical sensor based on a determined direction of optical sensor 106 within rotatable housing 104 and an orientation mode of electronic device 100.

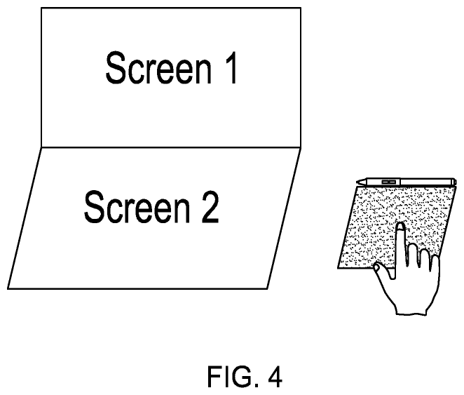

In some examples, the determined direction of optical sensor 106 within rotatable housing 104 may be zero degrees, wherein an opening of rotatable housing 104 disposing optical sensor 106 is directed outward from electronic device 100. In this scenario, a plane for the user input detection for optical sensor 106 is positioned parallel to the surface of the base of electronic device 100. Based on this determination, various operation modes may be determined. The operation modes may include a mode in which the user input is interpreted, such as a user input on a virtual touchpad, an upward or downward surface scroll gesture, a tapping air gesture, etc. Various example operation modes for a sensor orientation of zero degrees are described in FIGS. 4A-4D.

The operation modes may further be determined based on an orientation mode of electronic device 100 as determined by orientation sensor 112. For example, the orientation modes of electronic device 100 may indicate whether electronic device 100 is in a notebook mode, a tent mode, a tablet mode, a stand mode, or a book mode. A notebook mode may occur when electronic device 100 is opened approximately ninety degrees to a clamshell position which allows a user to place the base of electronic device 100 on an external surface. A tablet mode may occur when electronic device 100 is opened approximately 180 degrees which allows the base and/or top surface of electronic device 100 to be placed on an external surface. A tent mode may occur when electronic device 100 is opened more than 180 degrees to a tent position which allows the front edge of the base and the front edge of the top of electronic device 100 to be placed on the external surface. A stand mode may occur when electronic device 100 is opened more than 180 degrees which allows the top portion of the base of electronic device 100 to be placed on the external surface. A book mode may occur when electronic device 100 is opened more than approximately ninety degrees to an open book position which allows a side edge of the base and a side edge of the top of electronic device 100 to be placed on the external surface.

The different operation modes may be used by controller 110 to map and interpret various gestures received by optical sensor 106. The different operation modes may detect a slider motion by the user, such as an up-and-down slider motion or a left-and-right slider motion. For example, when electronic device 100 is in one operation mode, optical sensor 106 may detect a user motion starting from a location to the left of an external surface and ending at a location to the right on the external surface. Other operation modes may detect an air gesture, such as a user motion starting a point lower in the air and ending at a point higher in the air above optical sensor 106. Additional example operation modes may be used to detect a tap (either air or on an external surface) by the user, an air pointer gesture by the user, or a virtual touchpad input by the user. For example, if electronic device 100 includes a sensor orientation of zero degrees relative to the base surface of electronic device 100. When electronic device 100 is in a notebook mode or a tablet mode, optical sensor 106 is to detect a virtual touchpad input while in a first operation mode. The virtual touchpad is used by allowing the user to move around their finger or other selection tool (e.g., a stylus) on a surface external to electronic device 100. Optical sensor 106 may then detect the movement in the line of sight of the optical sensor and interpret the user input instructions.

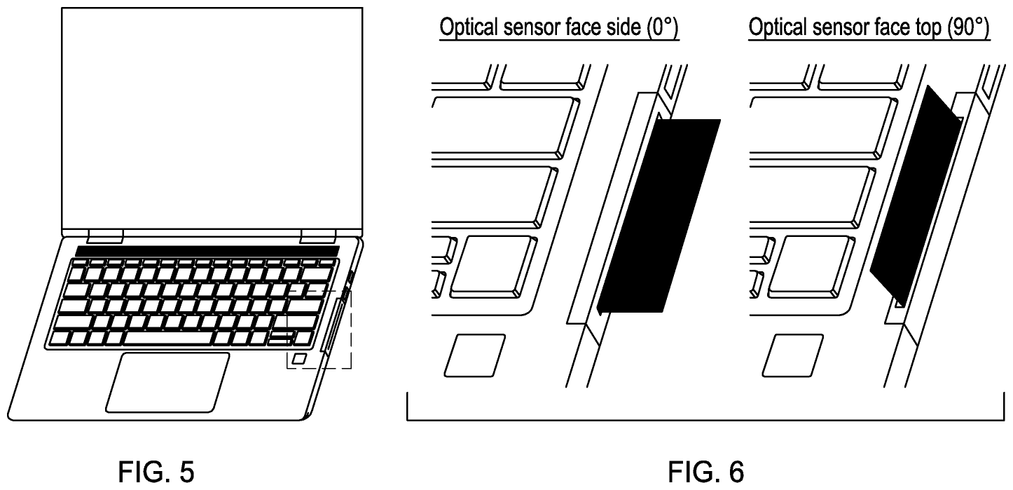

In some examples, the orientation of sensor 106 within rotatable housing 104 may be ninety degrees, wherein an opening of rotatable housing 104 disposing optical sensor 106 is directed perpendicular to the surface of the base of electronic device 100. In this scenario, a plane for the user input detection for optical sensor 106 is positioned perpendicular to the surface of the base of electronic device 100. Based on this determination, various operation modes may be determined. Various example operation modes for a sensor orientation of ninety degrees are described in FIGS. 5A-5D.

As shown in FIG. 1B, electronic device 100 may include physical keyboard 114, physical touchpad 116, and display 118. In some example scenarios, optical sensor 106 may be located to the side of physical keyboard 114, as shown in FIG. 1B. However, in other examples, optical sensor 106 may be located on a front edge of electronic device 100, such as below the space bar of physical keyboard 114 or below physical touchpad 116 of electronic device 100. In other example, electronic device 100 may include a display and the optical sensor may be located to the side of the display.

FIGS. 2A-B illustrate an electronic device 200 having a first sensor 206 and a second sensor 212 to detect an input, according to an example. Electronic device 200 includes a first housing 202 and a first rotatable housing 204. Electronic device 200 also includes a second housing 208 and a second rotatable housing 210. Furthermore, electronic device 200 includes physical keyboard 214, physical touchpad 216, and display device 218.

The first sensor 206 may be used to detect a first input from a first virtual touchpad. Furthermore, the first rotatable housing 206 may be mounted to a side of the first housing 202. As illustrated in FIG. 2B, the first sensor 206 is disposed in the first rotatable housing 204. The second sensor 212 may be used to detect a second input from a second virtual touchpad is disposed in the second rotatable housing 210. The second rotatable housing 210 may be mounted to the side of the second housing 208.

Still referring to FIGS. 2A-B, the first rotatable housing 204 disposing the first sensor 206 is mounted to the front edge of electronic device 200, such as below the space bar of physical keyboard 214 or below physical touchpad 216. Further in this example, the second rotatable housing 210 disposing the second sensor 212 is mounted to the side of physical keyboard 214.

In other examples, electronic device 200 may include a first display device and a second display device. In this example, the first rotatable housing 204 disposing the first sensor 206 is mounted to the side of the first display device. Further in this example, the second rotatable housing 210 disposing the second sensor 212 is mounted to the side of the second display device.

In yet another example, electronic device 200 may include both physical keyboard 214 and display device 218. In this example, first rotatable housing 204 disposing first sensor 206 may be located below the space bar of physical keyboard 214. Further in this example, second rotatable housing 210 disposing second sensor 212 may be located on the side of display device 218. In other examples, first rotatable housing 204 disposing first sensor 206 may be located below physical touchpad 216. Further in this example, second rotatable housing 210 disposing second sensor 212 may be located on the side of display device 218.

In some examples, a stylus communicatively may be coupled to the electronic device 200. In this example, first sensor 206 may be disposed in the stylus. It should be noted that in this example, the rotatable housing 204 may be an outer structure of the stylus. Second sensor 212 disposed in second rotatable housing may then be located on electronic device 200. In this example, a magnetic track may also be disposed in the stylus, along with first sensor 206. The magnetic track may be used to provide an attracting force to hold a portion of the stylus in contact with first housing 202.

Turning now to FIGS. 3A-B, a sensor orientation for a sensor of zero degrees and a sensor orientation for a sensor of ninety degrees may be determined, according to an example. Referring to FIG. 3A, a sensor orientation for a sensor having a detection field 300 of zero degrees is determined. Detection field 300 may be used to detect user motions or gestures within an input detection zone of an optical sensor, such as optical sensor 106. The user motions or gestures may then be processed and mapped to interpret the user inputs and apply the appropriate command for an application running on an electronic device. The sensor orientation may be determined by measuring an angle of the direction that the sensor is facing and the base of the electronic device. The sensor orientation may be determined by a direction sensor, such as direction sensor 108. As seen in FIG. 3A, the sensor is facing a direction parallel to the base of the electronic device. This allows detection field 300 to be parallel to the external surface and the sensor detect user inputs along a horizontal plane. The zero-degree angle between detection field 300 and the external surface is created by the sensor facing the direction parallel to the base of the electronic device creates sensor orientation of zero degrees.

Referring next to FIG. 3B, a sensor orientation of ninety degrees is determined, according to an example. Once again, the sensor orientation may be determined by measuring an angle of the detection field 302 and the external surface using a direction sensor, such as direction sensor 108. The sensor orientation having ninety degrees may occur when the faces a direction perpendicular to the base of the electronic device. As seem in FIG. 3B, the sensor is facing a direction perpendicular to the base of the electronic device which creates detection field 302. This allows the sensor to detect user inputs along a vertical plane. The ninety-degree angle between detection field 302 created by the sensor facing the direction perpendicular to the base of the electronic device creates the sensor orientation of ninety degrees.

FIGS. 4A-D illustrate operation modes for an electronic device 400 with a sensor orientation of zero degrees, according to another example. Referring first to FIG. 4A, a first operation mode is determined when the orientation of the sensor is at zero degrees and electronic device 400 is in a notebook mode. In this example, the detection field 402 is used to detect a virtual touchpad input in the first orientation mode. Referring next to FIG. 4B, a second operation mode is determined when the orientation of the sensor is at zero degrees and electronic device 400 is in a tent mode. In this example, the detection field 402 is used to detect an up-and-down slider motion or an up-and-down air gesture input in the second orientation mode.

Turning next to FIG. 4C, a third operation mode is determined when the orientation of the sensor is at zero degrees and electronic device 400 is in a stand mode. Here, the detection field 402 is used to detect a left-and-right slider motion or a left-and-right air gesture input in the third orientation mode. Finally, FIG. 4D illustrates that a fourth operation mode may be determined when the orientation of the sensor is at is at zero degrees and electronic device 400 is in a book mode. Detection field 402 may be used to detect an air pointer or a tap input in the fourth orientation mode.

FIGS. 5A-D illustrate operation modes for an electronic device 500 with an orientation of the sensor is at ninety degrees, according to another example. Referring first to FIG. 5A, a first operation mode is determined when the orientation of the sensor is at ninety degrees and electronic device 500 is in a notebook mode. In this example, detection field 502 is used to detect an air pointer or a tap input in the first orientation mode. Referring next to FIG. 5B, a second operation mode is determined when the orientation of the sensor is at ninety degrees and electronic device 500 is in a tent mode. In this example, is used to detect a left-and-right slider motion or a left-and-right air gesture input in the second orientation mode.

Turning next to FIG. 5C, a third operation mode is determined when the orientation of the sensor is at zero degrees and electronic device 500 is in a stand mode. Here, is used to detect a virtual touchpad input in the third orientation mode. Finally, FIG. 5D illustrates that a fourth operation mode may be determined when the orientation of the sensor is at zero degrees and electronic device 500 is in a book mode. Detection field 502 may be used to detect an up-and-down slider motion or an up-and-down air gesture input in fourth orientation mode.

FIGS. 6A-C is a illustrates a sensor rotation mechanism 600, according to another example. Sensor rotation mechanism 600 may be used to rotate the sensor 606, which is disposed in rotatable housing 604. Rotatable housing 604 may be located inside of housing 602. Sensor rotation mechanism 600 may be a biasing member which is used to attach rotatable housing 604 in housing 602. In this example, sensor rotation mechanism 600 may include a bi-stable spring 608. Referring first to FIG. 6A, sensor 606 has an orientation of ninety degrees. In this example, the bi-stable spring may be free which allows rotatable housing 604 to be locked in an upward facing direction within housing 602.

Referring next to FIG. 6B, sensor 606 has an orientation of forty-five degrees. In this example, the bi-stable spring may be compressed which does not allow rotatable housing 604 to be locked in either an upward facing direction within housing 602 or a downward facing direction within housing 602. Turning now to FIG. 6C, sensor 606 has an orientation of zero degrees. In this example, the bi-stable spring may be free which allows rotatable housing 604 to be locked in horizontal facing direction within housing 602.

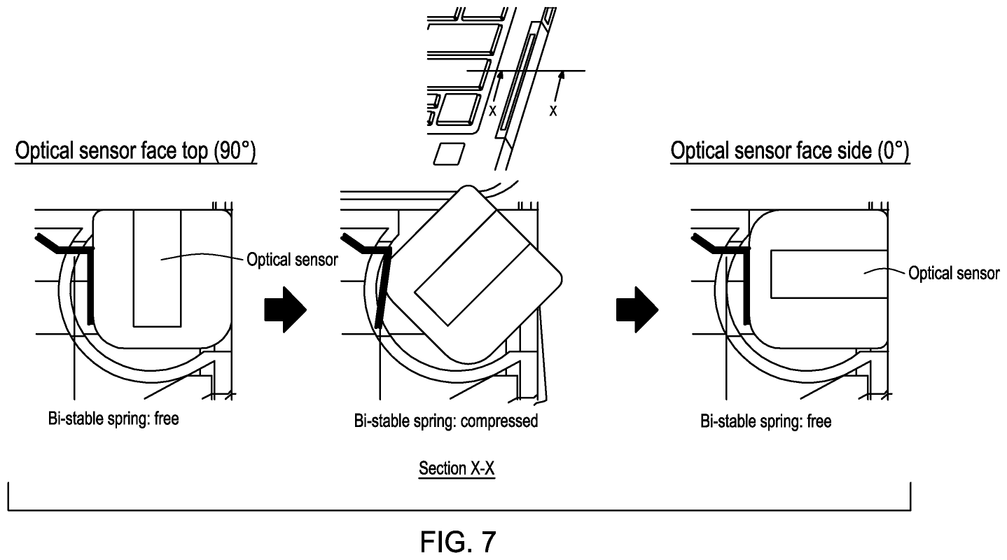

FIGS. 7A-B illustrates is a system of an electronic device and a stylus having a sensor to detect an input, according to another example. Referring to FIG. 7A, system 700 includes an electronic device 702 and a stylus 704. Referring to FIG. 7B, stylus 704 include an optical sensor 706 to detect an input for the electronic device 702. Stylus 704 also includes a body 712 and a tip 710. As illustrated in FIG. 7, the optical sensor 706 is disposed in the body 712 of stylus 704. Furthermore, optical sensor 706 may be oriented perpendicular to the tip of stylus 704, which may create a detection field 708 to receive user inputs which may be transmitted to electronic device 702 using a wireless communication device 716 of stylus 704 and a wireless communication device of electronic device 702 (not shown for clarity). Wireless communication device 716 may be implemented using a transceiver.

In some examples, electronic device 702 may also include a stylus controller 714. Stylus controller 714 may be used to direct optical sensor 706 disposed in stylus 704 to provide the virtual touchpad via detection field 708. The virtual touchpad provided by detection field 708 may be provided in response to a selection to enable a touchpad mode of the stylus 704 and disable a pen mode of stylus 704. Further in this example, stylus controller 714 may direct optical sensor 706 to detect the input for the virtual touchpad provided by detected field 708. Stylus controller 714 may also direct wireless communication device 716 within stylus 704 to communicate the input for the virtual touchpad provided by detection field 708 to electronic device 702. Stylus controller 714 may communicate the input for the virtual touchpad provided by detection field 708 by transmitting the input to electronic device 702 using wireless signaling, such as Bluetooth® and Wi-Fi®.

FIG. 8 illustrates a method 800 for operating an optical sensor in an electronic device, such as electronic device 100, according to another example. Method 800 includes determining an orientation of an optical sensor, at 802. For example, a direction sensor, such as direction sensor 108 of FIG. 1, may be used to determine whether the optical sensor has an orientation of zero degrees, ninety degrees, or some other orientation angle relative to the electronic device. Method 800 further includes determining a device orientation mode, at 804. For example, a controller in the system may determine whether the device is in notebook mode, tablet mode, a stylus mode, etc.

Method 800 further includes determining an operation mode for the electronic device based on the direction of the optical sensor and the device orientation mode, at 806. For example, based on a determination that the optical sensor has a direction of zero degrees and that the electronic device is in tent mode, it may be determined that the optical sensor is used to detect virtual inputs, according to a virtual touchpad operation mode.

Still referring to FIG. 8, method 800 further includes, in response to determining the operation mode, switching a mapping function of the optical sensor, at 808. This allows the inputs to be mapped to their correct function, such as mapping a left-to-right motion as a scroll from left to right. Method 800 further includes receiving inputs at the optical sensor, at 810. Method 800 further includes reporting the inputs to the electronic device, at 812. The inputs may then be reported at the direction of a controller for the optical sensor.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

What is claimed is:

1. An electronic device comprising:
a housing;
an optical sensor to detect an input from a detection zone;
a rotatable housing mounted to a side of the housing, wherein the optical sensor is disposed in the rotatable housing; and
a direction sensor to detect an orientation of the rotatable housing relative to the housing.

2. The electronic device of claim 1 further comprising a controller to determine an operation mode of the optical sensor based on the orientation of the rotatable housing.

3. The electronic device of claim 2 further comprising an orientation sensor to detect an orientation of the electronic device, wherein the controller is to determine the operation mode based on the orientation of the electronic device and the orientation of the rotatable housing.

4. The electronic device of claim 2 wherein the sensor orientation is zero degrees and wherein the operation mode comprises:
a first operation mode when the electronic device is in a notebook mode or a tablet mode, wherein the optical sensor is to detect a virtual touchpad input in the first operation mode;
a second operation mode when the electronic device is in a tent mode, wherein the optical sensor is to detect an up-and-down slider motion or an up-and-down air gesture input in the second operation mode;
a third operation mode when the electronic device is in a stand mode, wherein the optical sensor is to detect a left-and-right slider motion or a left-and-right air gesture input in the third operation mode; and
a fourth operation mode when the electronic device is in a book mode, wherein the optical sensor is to detect an air pointer or a tap input in the fourth operation mode.

5. The electronic device of claim 2 wherein the sensor orientation is ninety degrees and wherein the operation mode comprises:
a first operation mode when the electronic device is in a notebook mode, wherein the optical sensor is to detect an air pointer or a tap input in the first operation mode;
a second operation mode when the electronic device is in a tablet mode, wherein the optical sensor is to detect a left-and-right slider motion or a left-and-right air gesture input in the second operation mode;
a third operation mode when the electronic device is in a tent mode or a book mode, wherein the optical sensor is to detect a virtual touchpad in the third operation mode; and
a fourth operation mode when the electronic device is in a stand mode, wherein the optical sensor is to detect an up-and-down slider motion or an up-and-down air gesture input in the fourth operation mode.

6. The electronic device of claim 1 wherein the electronic device comprises a physical keyboard and wherein the rotatable housing disposing the optical sensor is mounted to the side of the physical keyboard.

7. The electronic device of claim 1 wherein the electronic device comprises a display device and wherein the rotatable housing disposing the optical sensor is mounted to the side of the display device.

8. An electronic device comprising:
a housing;
a first sensor to detect a first input from a first virtual touchpad;
a first rotatable housing mounted to a first side of the housing, wherein the first sensor is disposed in the first rotatable housing;
a second sensor to detect a second input from a second virtual touchpad; and
a second rotatable housing mounted to a second side of the housing, wherein the second sensor is disposed in the second rotatable housing.

9. The electronic device of claim 8 wherein the electronic device further comprises a physical keyboard, wherein the first rotatable housing disposing the first sensor is mounted to the front of the physical keyboard, and wherein the second rotatable housing disposing the second sensor is mounted to the side of the physical keyboard.

10. The electronic device of claim 8 wherein the electronic device further comprises:
a first display device, wherein the first rotatable housing disposing the first sensor is mounted to the side of the first display device; and
a second display device, wherein the second rotatable housing disposing the second sensor is mounted to the side of the second display device.

11. The electronic device of claim 8 wherein the electronic device further comprises:
a physical keyboard, wherein the first rotatable housing disposing the first sensor is located on the front of the physical keyboard; and
a display device, wherein the second rotatable housing disposing the second sensor is located on the side of the display device.

12. The electronic device of claim 8 further comprising:
a stylus communicatively coupled to the electronic device wherein, the first sensor is disposed in the stylus and wherein the rotatable housing comprises an outer structure of the stylus; and
a magnetic track disposed in the stylus, wherein the magnetic track is to provide an attracting force to hold a portion of the stylus in contact with the housing.

13. A system comprising:
an electronic device;
an optical sensor to detect an input for the electronic device; and
a stylus having a body and a tip, wherein the optical sensor is disposed in the body, wherein the optical sensor is oriented perpendicular to the tip, and wherein the stylus is to transmit the input to the electronic device.

14. The electronic device of claim 13 further comprising a stylus controller to:
direct the stylus to provide a virtual touchpad in response to a selection to enable a touchpad mode of the stylus and disable a pen mode of the stylus;
direct the optical sensor to detect the input for the virtual touchpad; and
direct a communication device within the stylus to communicate the input for the virtual touchpad to the electronic device.

15. The system of claim 13 wherein the stylus is to transmit the input to the electronic device using wireless signaling.
